(19) United States
(12) Patent Application Publication
(10) Pub. No.: US 2015/0114081 A1
(43) Pub. Date: Apr. 30, 2015

(54) COLLISION DETECTION SYSTEM AND FAILURE DETECTION METHOD

(71) Applicant: DENSO CORPORATION, Kariya-city (JP)

(72) Inventor: Masahiko IMOTO, Kariya-city (JP)

(21) Appl. No.: 14/513,308

(22) Filed: Oct. 14, 2014

(30) Foreign Application Priority Data
Oct. 24, 2013 (JP) 2013221308

(51) Int. Cl. G01L 27/00

(52) U.S. Cl. CPC G01L 27/005
USPC 73/1.57

(57) ABSTRACT

An outer panel and an inner panel of a vehicle door form a closed sealing chamber. A pressure sensor is attached to the inner panel to detect a pressure within the closed sealing chamber. The pressure sensor detects an increase in pressure caused by constriction of the closed sealing chamber when a collision occurs to a vehicle door. The in-vehicle speaker supplies a sound wave into the closed sealing chamber and detects, as an inspection pressure, a pressure in the closed sealing chamber when the sound wave is supplied. In an initial state of a vehicle, the inspection pressure is compared with an initial pressure threshold value, which is set based on a pressure in the closed sealing chamber generated when the sound wave is supplied. When the inspection pressure is equal to or lower than the initial pressure threshold value, it is detected that the air-tightness of the closed sealing chamber is lowered.

### CROSS REFERENCE TO RELATED APPLICATION

This application is based on and incorporates herein by reference Japanese patent application No. 2013-221308 filed on Oct. 24, 2013.

### FIELD

The present disclosure relates to a collision detection system and a failure detection method, which detect a collision of a vehicle.

### BACKGROUND

A conventional collision detection system disclosed in, for example, JP-A-2007-232566, is provided with a pressure sensor inside a side door of a vehicle to detect a collision by detecting changes in pressure inside the side door caused by the collision at a side surface of the vehicle. According to the conventional system, a side airbag is activated by detection of the collision of the vehicle to protect passenger from impact generated by the collision.

Further, according to the conventional collision detection system, when a switch for an audio device is turned on, amount of variation of a pressure signal within a predetermined time is detected and such an amount of variation is cancelled out from a detection output value of the pressure sensor at the time of detecting the collision. Thus at the time a collision is detected, a sound output from an in-vehicle speaker attached to the side door is restricted from affecting the collision detection result. Further, when the collision is detected under a state that an amount of variation of a solar radiation signal generated by a solar sensor is over a predetermined value, the amount of variation within the predetermined time is cancelled out from the pressure detection value. Thus, at the time of collision detection, influence of the variation in the solar radiation amount on the detection value of the pressure sensor is reduced.

In such a collision detection system as described above, a vehicle side door is repetitively opened and closed, vehicle chassis parts deteriorate with years or a vehicle user sometimes makes some structural changes to a vehicle chassis. Air-tightness in a space inside the vehicle door thus tends to decrease. When the air-tightness inside the side door decreases, the pressure inside the side door does not increase sufficiently and accuracy of collision detection decreases. It is necessary for this reason to detect that a collision detection system has a failure when the air-tightness within the vehicle door decreases.

The conventional collision detection system, on the other hand, removes external disturbances under a state that the collision detection system is operating normally. With this conventional collision detection system, users will not become aware of the failure of the collision detection system and will not be motivated to repair the vehicle.

### SUMMARY

It is therefore an object to provide a collision detection system and a failure detection method, which are capable of accurately detecting a failure caused by a drop in air-tightness inside a vehicle door.

According to one aspect, a collision detection system comprises: a pressure sensor attached to face a closed sealing chamber formed in a vehicle door and detect an increase of pressure caused by constriction of the closed sealing chamber; a collision determination part for determining a collision of a vehicle when the pressure in the closed sealing chamber is detected as being equal to or higher than a collision threshold value; a sound wave supply part for supplying a sound wave into the closed sealing chamber; an initial pressure storage part for storing an initial pressure threshold value set in accordance with a pressure in the closed sealing chamber at the time of supply of the sound wave in an initial state of the vehicle; and a failure detection part for comparing an inspection pressure value in the closed sealing chamber detected at a time of supply of the sound wave into the closed sealing chamber with the initial pressure threshold value, and detecting a failure of the collision detection system when the inspection pressure is equal to or lower than the initial pressure threshold value.

According to another aspect, a method of detecting a failure in a collision detection system comprises: a sound wave supply step for supplying a sound wave into a closed sealing chamber; and a failure detection step for comparing an inspection pressure in the closed sealing chamber detected at a time of supply of a sound wave into the closed sealing chamber with an initial pressure threshold value set in accordance with a pressure in the closed sealing chamber at the time of supply of the sound wave in an initial state of a vehicle, and detecting a failure of a collision detection system when the inspection pressure is equal to or lower than the initial pressure threshold value.

### BRIEF DESCRIPTION OF THE DRAWINGS

FIG. 1 is a block diagram showing a vehicle system, which is provided with a collision detection system according to a first embodiment;

FIG. 2 is a schematic cross-sectional view showing a vehicle door, to which a pressure sensor and a compartment speaker shown in FIG. 1 are attached;

FIG. 3A is a time chart showing a detection value of the pressure sensor when the collision detection system is normal;

FIG. 3B is a time chart showing a detection value of the pressure sensor when the collision detection system has a failure;

FIG. 4 is a control flowchart showing a failure detection method executed in the first embodiment;

FIG. 5 is a schematic cross-sectional view showing a vehicle door according to a modification of the first embodiment;

FIG. 6 is a block diagram showing a vehicle system, which is provided with a collision detection system according to a second embodiment; and

FIG. 7 is a schematic cross-sectional view showing a vehicle door, to which a pressure sensor and a horn shown in FIG. 6 are attached.

### DETAILED DESCRIPTION OF THE PREFERRED EMBODIMENT

### First Embodiment

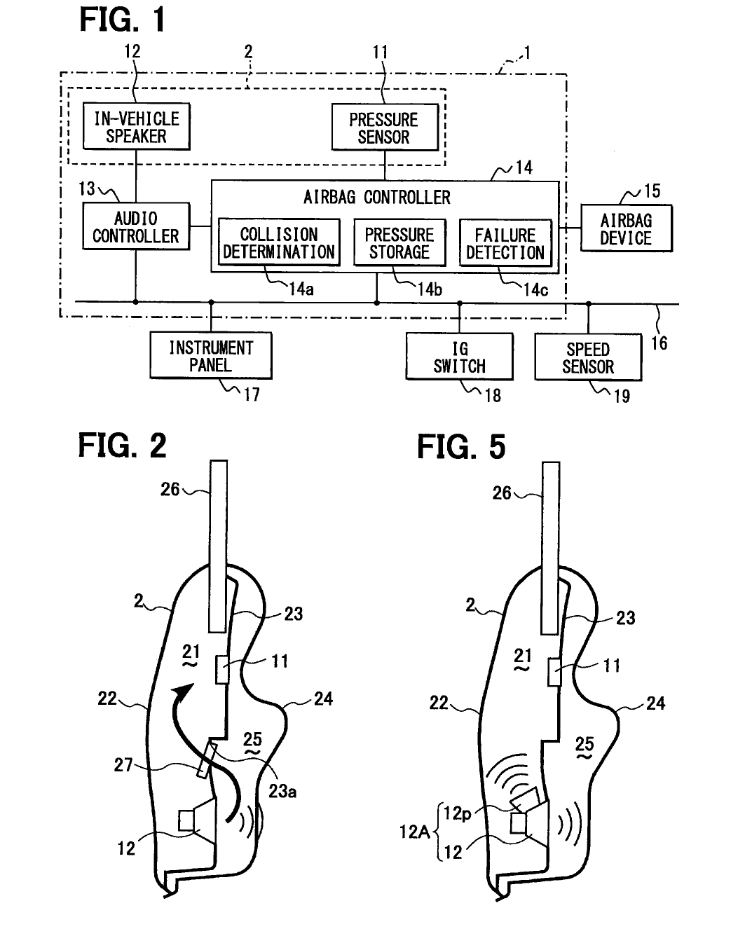

A collision detection system according to a first embodiment of the present disclosure will be described with reference to FIGS. 1 to 4.

As shown in FIG. 1, a collision detection system 1 is provided with a pressure sensor 11 and an in-vehicle speaker 12, which operates as sound wave supply means, which are attached to an inside of a vehicle door 2 of a vehicle (not shown). The vehicle door 2 is typically a side door or a vehicle. Sound output generated by the in-vehicle speaker 12 is referred to as a sound wave whether its frequency is in an audible band or in a non-audible band. The pressure sensor 11 is a semiconductor pressure sensor, in which a diffusion resistor is formed integrally on a silicon chip formed thinly. The pressure sensor 11 is capable of detecting an increase in pressure in a closed sealing chamber 21, which is a closed sealing space described below. The pressure sensor 11 may be formed differently from that described above. For example, it may be a type, which uses a strain gauge.

The in-vehicle speaker 12 is a conventional audio speaker and configured to output a sound wave toward a vehicle compartment based on sound data recorded in a music medium or data supplied from a navigation system mounted in the vehicle. The in-vehicle speaker 12 is also capable of generating a sound wave for detecting a failure of the collision detection system 1. This sound wave is in a non-audible frequency band (frequency, which is not audible to human ears and, for example, other than 20 to 20,000 Hz although not limited).

As shown in FIG. 2, the vehicle door 2 has an outer panel 22, which is an outside plate, and an inner panel 23, which is an inside plate. The vehicle door 2 is located to form a side end surface of the vehicle. The inner panel 23 is located at a vehicle compartment side relative the outer panel 22. The outer panel 22 and the inner panel 23 are both formed by press-forming a steel plate. The outer panel 22 and the inner panel 23 are integrated into one body by welding outer peripheral parts of the panels 22 and 23. A door trim 24, which is an interior member, is engaged with the vehicle compartment side of the inner panel 23. A sound chamber 25 is formed between the door trim 24 and the inner panel 23, which face each other, as a sound space. The door trim 24 is formed of a synthetic resin material. The door trim 24 has speaker holes in a lattice shape at its lower part although not shown.

A windshield glass 26 protrudes from a top end part of the vehicle door 2. The windshield glass 26 is provided to be movable in upward and downward directions between the outer panel 22 and the inner panel 23. As shown in FIG. 2, the closed sealing chamber 21 is formed inside the vehicle door 2 by the outer panel 22, the inner panel 23 and the windshield glass 26. The closed sealing chamber 21 need not be sealed completely to resist high pressures from external space. The closed sealing chamber 21 need only be sealed from the external space with a sealing force sufficient to prevent water from entering. The closed sealing chamber 21 may be communicated with the external space through small drain holes or the like provided at a bottom part of the vehicle door 2.

The pressure sensor 11 is fixedly attached to the inner panel 23. The pressure sensor 11 is attached to face the closed sealing chamber 21 to detect a pressure increase in the closed sealing chamber 21, which results from constriction of the closed sealing chamber 21 due to collision to the vehicle door 2 by any other obstacles such as other vehicles. The in-vehicle speaker 12 is attached to the bottom part of the inner panel 23 to face the vehicle compartment so that the sound wave outputted from the in-vehicle speaker 12 propagates into the vehicle compartment through the sound chamber 25 and speaker holes.

A through hole (penetration hole) 23a passes through the inner panel 23 to communicate the closed sealing chamber 21 and the sound chamber 25. A shut-off valve 27 is attached as a communication control or on/off valve to the inner panel 23 rotatably about its top end in FIG. 2 as a center of rotation. Although not shown, a spring is interposed between the shut-off valve 27 and the inner panel 23 to bias the shut-off valve 27 in the counter-clockwise direction in FIG. 2 by spring force. Thus the shut-off valve 27 operates as a one-way valve, which normally closes the through hole 23a from the closed sealing chamber 21 side. As a result, when the closed sealing chamber 21 is constricted by the collision to the vehicle door 2, the shut-off valve 27 remains in the valve-closing state and the pressure in the closed sealing chamber 21 is allowed to increase so that the pressure sensor 11 can detect a collision based on a pressure increase in the closed sealing chamber 21. When the sound wave is supplied to the sound chamber 25 from the in-vehicle speaker 12 for detecting the failure in the collision detection system 1, the shut-off valve 27 opens the through hole 23a against the biasing force of the spring by the supplied sound wave. The sound wave outputted from the in-vehicle speaker 12 is allowed to propagate from the sound chamber 25 into the closed sealing chamber 21.

Referring back to FIG. 1, an audio controller 13 is connected to the in-vehicle speaker 12. The audio controller 13 includes a driver for retrieving music data from a data medium, an amplifier, a tuner and the like. The audio controller 13 transmits a sound signal to the in-vehicle speaker 12 so that the in-vehicle speaker 12 responsively generates the sound wave.

An airbag controller 14 is connected to the pressure sensor 11. The airbag controller 14 is a control device, which is formed of an input/output unit, a CPU, a RAM and the like. The airbag controller 14 includes a collision determination part 14a operating as collision determination means, a storage part 14b operating as initial pressure storage means and a failure detection part 14c operating as failure detection means. The collision determination part 14a determines that the vehicle had a collision when the pressure sensor 11 detects that the pressure value inside the closed sealing chamber 21 exceeds a predetermined collision threshold value. In the initial state of the vehicle, the storage part 14b stores an initial pressure threshold value Pth, which is set as a comparison reference based on the pressure value in the closed sealing chamber 21 generated when the sound wave is supplied from the in-vehicle speaker 12. The initial pressure threshold value Pth is different from the collision threshold value, specifically lower than the collision threshold value. The failure detection part 14c compares, with the initial pressure threshold value Pth, an inspection pressure value Pisp, which is the detected pressure inside the closed sealing chamber 21 at the time of supply of the sound wave from the in-vehicle speaker 12 into the closed sealing chamber 21. The failure detection part 14c detects the failure in the collision detection system 1 when the inspection pressure value Pisp is equal to or lower than the initial pressure threshold value Pth. The collision determination part 14a may be configured to determine the collision of the vehicle based on a check result of a detection value of an acceleration sensor of a vehicle in addition to the detection value of the pressure sensor 11. The pressure storage part 14b may be a magnetic memory unit or a semiconductor memory unit. The failure detection part 14c may be provided with a function of initially checking an airbag system.

The airbag device 15 is connected to the airbag controller 14. The airbag device 15 is a conventional type, which is formed of an inflator, a bag and an igniter although not shown. The airbag controller 14 activates the airbag device 15 when the collision determination part 14a determines the collision of the vehicle.

The audio controller 13 is connected to the airbag controller 14 through an in-vehicle LAN. In addition, an instrument panel 17, an ignition (IG) switch 18 and a vehicle speed sensor 19 are connected to the airbag controller 14 through the in-vehicle LAN 16. The instrument panel 17 is provided in front of a driver's seat in the vehicle to be activated as alarm means for notifying the driver of failure by lighting when the collision detection system 1 fails. The ignition switch 18 is provided near the driver's seat as a start switch to start a power source of the vehicle such as an engine or a motor. The vehicle speed sensor 19 is a sensor, which indirectly detects a vehicle travel speed from a rotation shaft speed of a transmission or a vehicle wheel speed.

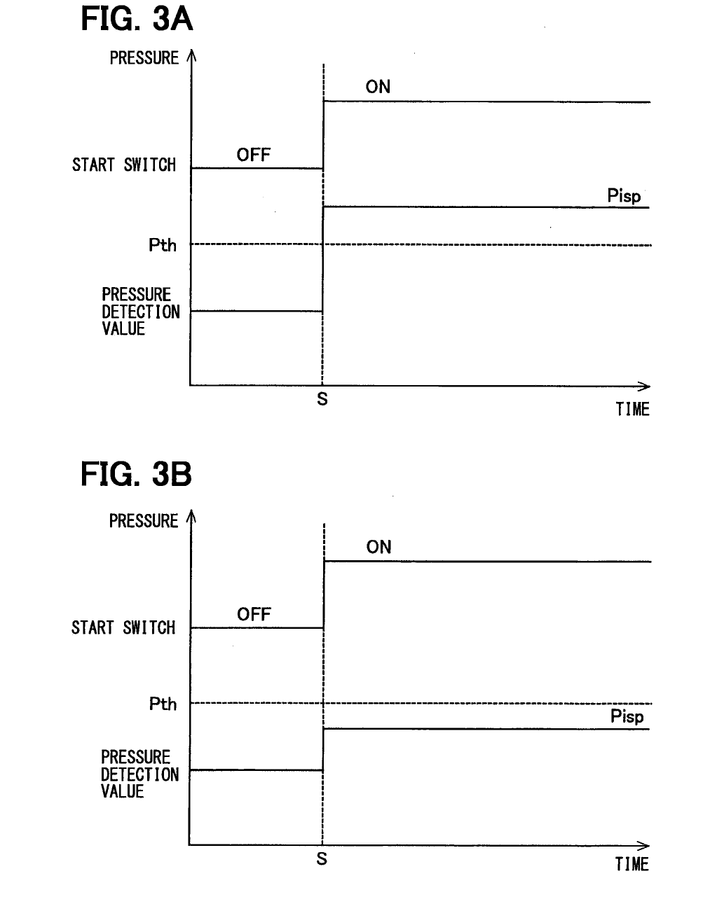

A method of detecting the failure in the collision detection system 1 by the failure detection part 14c will be described next with reference to FIG. 3A and FIG. 3B. In FIG. 3A and FIG. 3B, a horizontal axis indicates time and vertical axes indicates a pressure in the closed sealing chamber 21 detected by the pressure sensor 11, that is, sound pressure supplied from the in-vehicle speaker 12, and an operation of the start switch of the in-vehicle speaker 12. Pth indicates the initial pressure threshold value, which is set under the initial state of the vehicle (for example, at the time of vehicle production or shipment). The initial pressure threshold value Pth is set to be a predetermined value lower than the pressure value in the closed sealing chamber 21, which is developed normally when the sound wave is supplied by the in-vehicle speaker 12. As described above, the initial pressure threshold value Pth is stored in the pressure storage part 14b. The initial pressure threshold value Pth may be predetermined by actually measuring the pressure of each vehicle by supplying the sound wave into the closed sealing chamber 21 at the time of vehicle shipment or may be predetermined to the same value based on design data of the vehicle door 2 without actually measuring the pressure of each vehicle.

When the collision detection system 1 is normal, as shown in FIG. 3A, the pressure value Pisp corresponding to inspection pressure in the closed sealing chamber 21 detected by the pressure sensor 11 increases above the initial pressure threshold value Pth at the time the in-vehicle speaker 12 is switched from an off-state to an on-state and the sound wave is supplied from the sound chamber 25 into the closed sealing chamber 21 (time S in FIG. 3A). Thus the collision detection system 1 is detected as being normal (no failure or abnormality). When the sound wave is generated from the in-vehicle speaker 12, it is necessary to set the sound pressure of the sound wave to be equal to or higher than a predetermined pressure so that the air-tightness of the closed sealing chamber 21 may be determined. When the collision detection system has a failure and is not normal because of insufficient air-tightness of the closed sealing chamber 21, inoperativeness of the pressure sensor 11 or the like, as shown in FIG. 3B, the inspection pressure value Pisp in the closed sealing chamber 21 increases only slightly even when the in-vehicle speaker 12 is switched from the off-state to the on-state and the sound wave is supplied form the sound chamber 25 into the closed sealing chamber 21 (time S in FIG. 3B). Thus the collision detection system 1 is detected as being failing (abnormal).

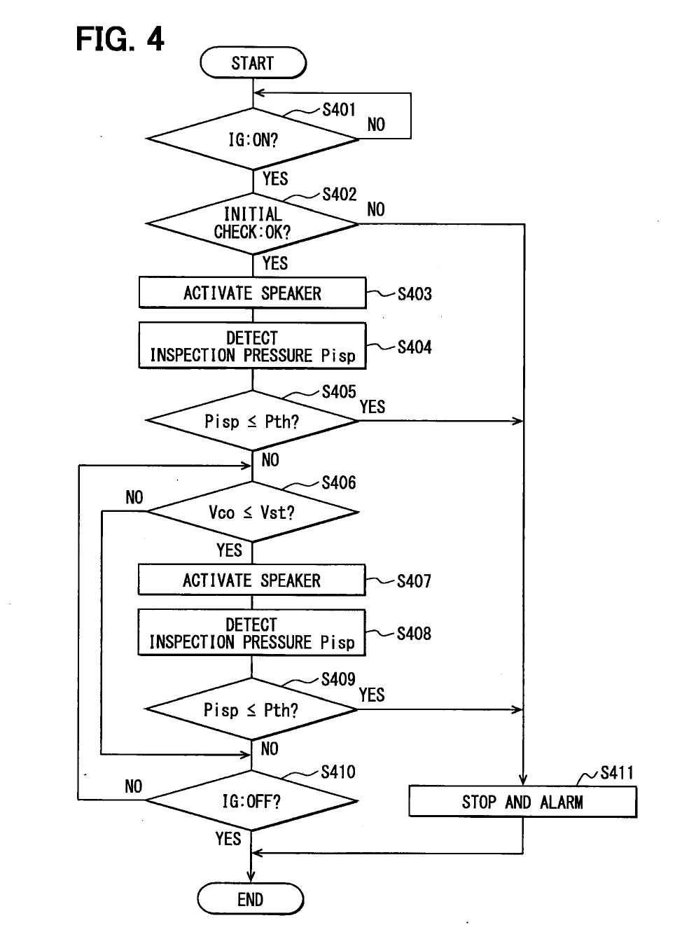

A method of detecting a failure of the collision detection system 1, which the airbag controller 14 performs, will be described with reference to a control flowchart shown in FIG. 4. When the ignition switch 18 is turned on (step S404) for starting an operation of the vehicle, an initial check is executed on the airbag system (step S402), which includes the airbag controller 14 and the airbag device 15. The initial check is executed with respect to inoperativeness of each actuator due to sticking, electric disconnection of each part and the like. When an abnormality is detected by the initial check, the airbag system is stopped from operating (step S411). Further, at this time, the failure is notified to a driver by an alarm of lighting a specified location or light on the instrument panel 17.

When no abnormality is detected by the initial check, a speaker operation signal is transmitted from the airbag controller 14 to the audio controller 13 so that the in-vehicle speaker 12 is activated and outputs the sound wave in the non-audible band (step S403: sound wave supplying step). This sound wave propagates into the closed sealing chamber 21 through the through hole 23a against the shut-off valve 27. Then the inspection pressure value Pisp in the closed sealing chamber 21; which is increased with the propagation of the sound wave, is detected by the pressure sensor 11 (step S404). The detected inspection pressure value Pisp is compared with the initial pressure threshold value Pth by the failure detection part 14c (step S405: failure detection step). When the inspection pressure value Pisp is equal to or lower than the initial pressure threshold value Pth, the collision detection system 1 is detected as having a failure such as insufficient air-tightness of the closed sealing chamber 21. The airbag system is stopped from operating and an alarm is issued to a river in the compartment (step S411).

When the inspection pressure value Pisp is higher than the initial pressure threshold value Pth, that is, when the collision detection system 1 is normal, it is checked whether a present vehicle speed Vco is equal to or lower than a predetermined low speed Vst, which is sufficiently close to 0 (step S406). When the vehicle speed Vco is higher than the low speed Vst, the vehicle is determined as being traveling and not being at rest. Then it is checked whether the ignition switch 18 of the vehicle is turned off (step S410). When the ignition switch 18 is turned off, the present control processing is finished. If the ignition switch 18 is not turned off, it is checked again at step S406 whether the vehicle speed Vco is equal to or lower than the low speed Vst.

When the vehicle speed Vco is determined to be equal to or lower than the low speed Vst, the vehicle is determined to be at rest, that is, stopped, and the sound wave in the non-audible band is outputted from the in-vehicle speaker 12 (step S407: sound wave supply step). After the inspection pressure value Pisp in the closed sealing chamber 21 is detected (step S408), the detected pressure is compared with the initial pressure threshold value Pth by the failure detection part 14c (step S409: failure detection step). When the inspection pressure value Pisp is equal to or lower than the initial pressure threshold value Pth, the airbag system is stopped from operating and the driver is alarmed (step S411). When the inspection pressure value Pisp is higher than the initial pressure threshold value Pth, step S410 is executed.

According to the first embodiment, the failure detection part 14c is provided to detect that there is a failure when the inspection pressure value Pisp is equal to or lower than the initial pressure threshold value Pth, by comparing the inspection pressure value Pisp in the closed sealing chamber 21 detected at the time of supply of the sound wave from the in-vehicle speaker 12 into the closed sealing chamber 21 with the initial pressure threshold value Pth. When the air-tightness of the closed sealing chamber 21 falls or the pressure sensor 11 becomes inoperative, the inspection pressure value Pisp in the closed sealing chamber 21 at the time of supply of the sound wave falls below the initial pressure threshold value Pth. For this reason, the failure of the collision detection system 1 can be detected accurately.

Since the sound wave outputted from the in-vehicle speaker 12 is in the non-audible band and hence not audible to passengers, the passengers will not be annoyed by such a sound wave at the time of failure detection. For this reason, the above-described failure detection need not be limited to only when the ignition switch 18 is turned on but may be performed at any other time. The failure detection part 14c is connected to the instrument panel 17 of the vehicle and issues the alarm to the passenger at the time of detection of the failure. Thus, the passenger can recognize the failure of the collision detection system 1 and takes the vehicle to a repair shop at the earliest convenience. Further, since the in-vehicle speaker 12 attached to the vehicle door 2 is used as the sound wave supply means, the existing device can be used efficiently and extra work for attaching a new device can be saved.

The vehicle door 2 is provided with the outer panel 22, the inner panel 23 and the door trim 24. The outer panel 22 is located at the outer peripheral end of the vehicle. The inner panel 23 is attached to face the vehicle compartment side relative to the outer panel 22 and form the closed sealing chamber 21 jointly with the outer panel 22. The door trim 24 is attached to face the vehicle compartment side relative to the inner panel 23 and form the sound chamber 25 jointly with the inner, panel 23. The in-vehicle speaker 12 is attached to face the sound chamber 25 relative to the inner panel 23. The inner panel 23 is provided with the through hole 23a, which communicates the closed sealing chamber 21 and the sound chamber 25. The shut-off valve 27 is provided to open and close the through hole 23a. The shut-off valve 27 remains closed even when the pressure in the closed sealing chamber 21 rises. The shut-off valve 27 opens when the sound wave is supplied into the sound chamber 25. With this simple construction described above, the collision detection system 1 can be configured to detect both of the collision to the vehicle and the failure of the system.

Since the in-vehicle speaker 12 supplies the sound wave into the closed sealing chamber 21 when the ignition switch 18 is turned on, the failure detection can be performed following the initial check of the vehicle. Thus the failure detection can be performed without annoying the passenger of the vehicle. Since the in-vehicle speaker 12 supplies the sound wave into the closed sealing chamber 21 each time the vehicle stops after the ignition switch 18 is turned on, possibility of collision of the vehicle during the failure detection operation can be reduced. Both the detection of collision to the vehicle and the detection of failure can performed.

According to the failure detection method performed by the collision detection system 1, sound wave supply steps S403, S407 and failure detection steps S405, S409 are provided. At steps S403, S407, the sound wave is supplied into the closed sealing chamber 21. At steps S405, S409, the inspection pressure value Pisp detected at the time of supply of the sound wave into the closed sealing chamber 21 is compared with the intial pressure threshold value Pth, which is set based on the pressure in the closed sealing chamber 21 detected at the time of supply of the sound wave in the initial state of the vehicle. When the inspection pressure value Pisp is equal to or lower than the initial pressure threshold value Pth, the failure of the collision detection system 1 is detected. When the air-tightness of the closed sealing chamber 21 is lowered or the pressure sensor 11 is not normal, the inspection pressure value Pisp in the closed sealing chamber 21 detected at the time of supply of the sound wave is lowered to the initial pressure threshold value Pth or more, the failure can be detected with high accuracy.

### Modification of First Embodiment

Referring to FIG. 5, a modification of the first embodiment will be described with respect to only differences from the first embodiment. In FIG. 5, same structural parts as those of FIG. 2 are indicated with the same reference numerals.

In this modification, the in-vehicle speaker 12 attached to the inner panel 23 is provided with a sub-speaker 12p, which is also the sound wave supply means and capable of generating a sound wave of a frequency in the non-audible band. This sub-speaker 12p provides a two-way speaker device 12A jointly with the in-vehicle speaker 12. The speaker 12p is attached to face the closed sealing chamber 21 and operable by the audio controller 13 similarly to the in-vehicle speaker 12. The sub-speaker 12p generates and directly supplies into the closed sealing chamber 21 the sound wave at the time of failure detection of the collision detection system 1. When a sound of a music medium or a navigation system is generated, the in-vehicle speaker 12 is used.

According to this modification, since the sub-speaker 12p is provided, the inner panel 23 need not be provided with the through hole 23a and the shut-off valve 27, which are provided in the first embodiment.

### Second Embodiment

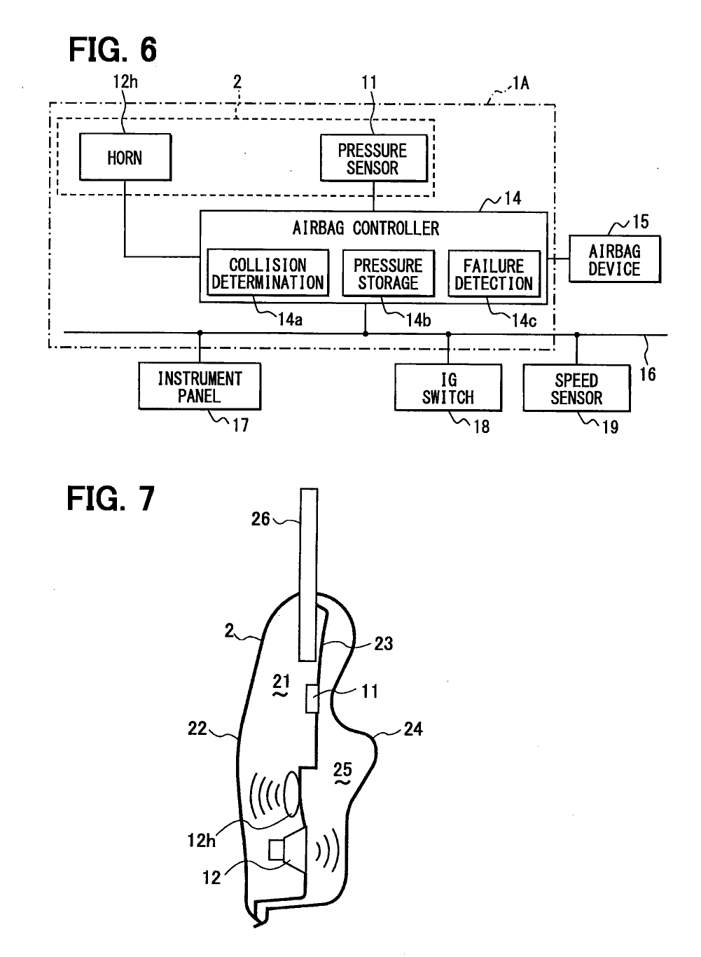

Referring to FIG. 6 and FIG. 7, a collision detection system 1A according to a second embodiment will be described with respect to only differences from the first embodiment. In FIG. 6 and FIG. 7, same structural parts as those of FIG. 1 and FIG. 2 are indicated with the same reference numerals. As shown in FIG. 7, a buzzer horn 12h, which operates as the sound wave supply means and capable of generating a sound wave of a frequency in the non-audible band is provided to the inner panel 23 in addition to the in-vehicle speaker 12. The horn 12h is attached to face the closed sealing chamber 21 and formed to be operable by the airbag controller 14 differently from the in-vehicle speaker 12 as shown in FIG. 6. The horn 12h generates and supplies directly into the closed sealing chamber 21 the sound wave at the time of failure detection of the collision detection system 1. When a sound of a music medium or a navigation system is generated, the in-vehicle speaker 12 is used. According to this embodiment, since the horn 12h is provided, the inner panel 23 need not be provided with the through hole 23a and the shut-off valve 27.

### Other Embodiment

The present disclosure is not limited to the above-described embodiments but may be modified as exemplified below. The collision detection system 1 according to the present disclosure may be used to detect not only the collision to the side door of the vehicle but also a collision to a rear door and the like. The sound wave supply means may be an ultrasonic wave generator device other than the in-vehicle speaker 12 or the horn 12h. As alarm means for the passenger of the vehicle at the time of failure of the collision detection system 1, the notification may be performed by generating a sound in place of or in addition to lighting the specified location of the instrument panel 17. Further, the failure detection of the collision detection system 1 need not be performed at every turning on of the ignition switch 18 or at every stopping of the vehicle but may be performed only once in a day at the turning on of the ignition switch 18.

What is claimed is:

1. A collision detection system comprising:
a pressure sensor attached to face a closed sealing chamber formed in a vehicle door and detect an increase of pressure caused by constriction of the closed sealing chamber;
a collision determination part for determining a collision of a vehicle when the pressure in the closed sealing chamber is detected as being equal to or higher than a collision threshold value;
a sound wave supply part for supplying a sound wave into the closed sealing chamber;
an initial pressure storage part for storing an initial pressure threshold value set in accordance with a pressure in the closed sealing chamber at the time of supply of the sound wave in an initial state of the vehicle; and
a failure detection part for comparing an inspection pressure value in the closed sealing chamber detected at a time of supply of the sound wave into the closed sealing chamber with the initial pressure threshold value, and detecting a failure of the collision detection system when the inspection pressure is equal to or lower than the initial pressure threshold value.

2. The collision detection system according to claim 1, wherein:
the sound wave supplied by the sound wave supply part is a sound wave in a non-audible band.

3. The collision detection system according to claim 1, further comprising:
an alarm for a passenger of the vehicle,
wherein the failure detection part is connected to the alarm to activate the alarm upon detection of the failure.

4. The collision detection system according to claim 1, wherein:
the sound wave supply part includes a speaker attached to the vehicle door.

5. The collision detection system according to claim 4, wherein:
the vehicle door includes an outer panel located at an outer peripheral end of the vehicle, an inner panel attached to face an inside of a vehicle compartment and form the closed sealing chamber with the outer panel, and an interior member attached to the inner panel to face the inside of the vehicle compartment and form a sound chamber with the inner panel;
the speaker is attached to the inner panel to face the sound chamber;
the inner panel is provided with a through hole, which communicates the closed sealing chamber and the sound chamber, and a shut-off valve for opening and closing the through hole; and
the shut-off valve remains in a closed-valve state against an increase in the pressure in the closed sealing chamber and opens in response to the sound wave supplied from the sound chamber.

6. The collision detection system according to claim 1, wherein:
the sound wave supply part supplies the sound wave into the closed sealing chamber when a start switch of the vehicle is turned on.

7. The collision detection system according to claim 1, wherein:
the sound wave supply part supplies the sound wave into the closed sealing chamber when the vehicle stops after a start switch of the vehicle is turned on.

8. A method of detecting a failure in a collision detection system, which is provided with a pressure sensor and a collision determination part, a pressure sensor being attached to face a closed sealing chamber formed in a vehicle door and detect an increase of pressure caused by constriction of the closed sealing chamber, the collision determination part determining a collision of the vehicle when the pressure in the closed sealing chamber is equal to or higher than a collision threshold value, the method comprising:
a sound wave supply step for supplying a sound wave into the closed sealing chamber; and
a failure detection step for comparing an inspection pressure in the closed sealing chamber detected at a time of supply of the sound wave into the closed sealing chamber with an initial pressure threshold value set in accordance with the pressure in the closed sealing chamber at the time of supply of the sound wave in an initial state of the vehicle, and detecting a failure of the collision detection system when the inspection pressure is equal to or lower than the initial pressure threshold value.
